(19) United States
(12) Patent Application Publication
(10) Pub. No.: US 2022/0369263 A1
(43) Pub. Date: Nov. 17, 2022

(54) PROPAGATION DELAY COMPENSATION TOOLBOX

(71) Applicant: Telefonaktiebolaget LM Ericsson (publ), Stockholm (SE)

(72) Inventors: Bikramjit SINGH, Kirkkonummi (FI); John Walter DIACHINA, Garner, NC (US); Magnus SANDGREN, Staffanstorp (SE)

(21) Appl. No.: 17/765,652

(22) PCT Filed: Oct. 5, 2020
(86) PCT No.: PCT/SE2020/050938

§ 371 Date: Mar. 31, 2022

Related U.S. Application Data
(60) Provisional application No. 62/911,088, filed on Oct. 4, 2019.

(51) Int. Cl. H04W 56/00

(52) U.S. Cl. CPC H04W 56/0045; H04W 56/0065; H04W 56/002

(57) ABSTRACT

A method, system and apparatus are disclosed. In one or more embodiments, a network node for a wireless communication system is provided. The network node includes processing circuitry configured to: send a wireless system clock and a network clock different from the wireless system clock where the network clock is adjustable based at least on the wireless system clock; determine one of a plurality of Propagation Delay (PD) compensation schemes for a first wireless device to implement based at least in part on at least one characteristic associated with the first wireless device; and indicate the one of the plurality of PD compensation schemes to the first wireless device for adjustment of the wireless system clock.

### TECHNICAL FIELD

The present disclosure relates to wireless communications, and in particular, to obtaining a propagation delay (PD) compensation scheme from among various PD compensation schemes based at least in part on at least one characteristic associated with the wireless device.

### BACKGROUND

3^{rd} Generation Partnership Project (3GPP) 5^{th} Generation (5G) New Radio (NR) standards may support Time Sensitive Network (TSN), i.e., 5G integrated in Ethernet-based industrial communication networks. Some use cases relate to factory automation networking.

The problem of clock inaccuracy/uncertainty may be inherent in methods for relaying the internal 5G system clock (also referred to as the wireless system clock or 5GS time) from a source network node in the 5G system to wireless devices supporting Industrial Internet of Things (IIoT) end devices (i.e., IIoT wireless devices). This inaccuracy may relate to an error introduced as a result of the Radio Frequency (RF) propagation delay that occurs when a network node (e.g., gNB) transmits a 5G system clock over the radio interface within a message (e.g., SIB or RRC unicast based) where the propagation delay needs to be compensated for to help ensure the clock value received by the wireless device is as close as possible to the value of that clock in the corresponding source network node (e.g., a gNB with knowledge of the 5G internal system clock). In other words, the better the accuracy of relaying the 5G system clock from the source network node to the wireless device the better the accuracy that may be realized when external TSN clocks are relayed from a TSN grandmaster (GM) network node through the 5G system to wireless devices (and subsequently to end-stations). For example:
Ingress timestamping may be performed when an external TSN clock is received by a 5G system and egress timestamping is performed when that TSN clock (relayed through the 5G system) arrives at the wireless device.
Note: Since the TSN GM clock can have an arbitrary placement, the ingress time stamping can be performed at various places within the 5G system (5GS), e.g., at the User Plane Function (UPF)-TSN translator (TT) or at the wireless device-TT.
The difference between the two timestamps is a reflection of the 5G residence time which may be used to adjust the value of the external TSN clock.
The timestamping is based on the internal 5G system clock and the accuracy of delivering this clock to a wireless device may be improved by allowing the propagation delay experienced (when sending this clock from the network node to a wireless device) to be more precisely determined.

An additional source of inaccuracy may occur as a result of subsequent wireless device distribution of the clock to IIoT end devices (i.e., wireless devices) which is needed to enable TSN functionalities, e.g., Time-Aware Scheduling of IIoT device operations specific to the working domain (a specific factory area) associated with a given working clock.

There are different methods, such as legacy Timing Advance (TA), that can be used to estimate and compensate for delay propagation. For example, 3GPP Timing Advance command may be utilized in cellular communication for uplink transmission synchronization. It is further classified as two types:
1. In the beginning, at connection setup, an absolute timing parameter is communicated to a wireless device using Medium Access Control (MAC) Random Access Response (RAR) element,
2. After connection setup, a relative timing correction can be sent to a wireless device using MAC Control Element (CE) element (e.g., wireless devices can move or due to RF channel changes caused by the environment).

The downlink Propagation Delay (PD), can be estimated, for example, for a wireless device by (a) first summing the TA value indicated by the RAR (random access response) and all subsequent TA values sent using the MAC CE control element and (b) taking some portion of the total TA value resulting from summation of all the TA values (e.g., 50% could be used assuming the downlink and uplink propagation delays are essentially the same).

The PD can be utilized to understand time synchronization dynamics, e.g., for accurately tracking the value of a clock at the wireless device side relative to the value of that clock in some other network node.

However, existing procedures for sending a 5G system clock from a network node to a wireless device include, as also discussed above:
SIB broadcasting wherein a specific SIB message includes a value for the 5G system clock having a value that is relative to a specific point in the System Frame Number (SFN) structure (e.g., the end of the last SFN may be used for sending system information).
RRC unicast wherein a dedicated RRC message is used to send a specific wireless device a value for the 5G system clock having a value that is relative to a specific point in the SFN structure (e.g., end of SFNx).

Since the definitions of the 5GS clock above relates to when the SFN reference point occurs at the network node antenna, individual compensation for RF air propagation delay (PD) between network node and the wireless device may be needed for the wireless device to accurately compensate and derive a correct and aligned 5GS clock time at the wireless device.

There are different methods that have been proposed that can be used to estimate and compensate for delay propagation. In practice, one method might be best during certain conditions and towards a specific wireless device while another one might be best for another wireless device even if served by same network node. How to best select most appropriate method both for fulfilling TSN end to end timing accuracy and minimize signaling overhead among a multitude of possibilities based on a multitude of input parameters is not defined in wireless device communication standards such as 3GPP.

### SUMMARY

In one or more embodiments, the present disclosure advantageously describes methods based on various conditions, requirements and capabilities to select most appropriate PD compensation method for an individual wireless device, i.e., to select a PD compensation method among a plurality of PD compensation methods based at least in part on at least one of: one or more conditions, one or more requirements, and one or more capabilities. For example, in one or more embodiments, different methods for realizing the amount of PD compensation to be applied wherein various conditions and capabilities are to be considered in order to select the most appropriate PD compensation method.

Some embodiments advantageously provide methods, systems, and apparatuses for obtaining a propagation delay (PD) compensation scheme from among various PD compensation schemes based at least in part on at least one characteristic associated with the wireless device.

In the cell, wireless devices' transmission/reception behavior may not be the same due to randomness in the wireless channel and hardware characteristics/uncertainties like the wireless communication standards such as 3GPP Technical Specification (TS) 38.133 specified Te (with unknown error distribution between TX and RX branches and its potential variation over time). The actual RF propagation delay between the network node and a specific wireless device may depend on cell size and the wireless device relative position within the cell with dependencies on whether LOS or NLOS is applicable at a point when a wireless device is sent a 5GS clock. Different wireless devices can serve TSN end devices (i.e., other wireless devices) with different levels of required accuracy for the TSN clocks used by these TSN end devices as defined in wireless communication standards such as in 3GPP TS 22.104 (i.e., ranging from 1 us to 100 us).

Therefore, in one or more embodiments, acceptable error introduced for TSN clocks used by TSN end devices due to RF propagation delay can be different between individual wireless devices and therefore the most suitable method for PD compensation can also vary for different wireless devices. For at least this reason, one or more embodiments described herein provide a PD toolbox that enables the use of different PD compensation methods/solutions for different wireless devices in the (same) cell or network depending (i.e., based at least in part on) on their Over-the-Air (OTA) behavior and/or wireless device's hardware constraints, i.e., at least one characteristic associated with a wireless device.

One or more embodiments described herein may use one or more of various conditions, requirements and capabilities to select most appropriate PD compensation method for each individual wireless device.

By taking a multitude or at least one of a plurality of factors into account each individual wireless device may be able to use the most suitable PD method and scheme that is most appropriate towards achieving sufficient accuracy in deriving 5GS time at the time instances where the 5GS chooses to deliver 5GS time to a wireless device or a (logical) group of wireless devices in the cell.

The PD method selected can also consider the aspect of minimizing the required signaling overhead to a minimum or below a predefined threshold in the interest of minimizing interference and power consumption. Low signaling overhead methods may be of special interest considering 5G systems experiencing high traffic volume, high levels of noise or battery operated wireless devices/end devices.

According to one aspect of the disclosure, a network node for a wireless communication system is provided. The network node includes processing circuitry configured to: send a wireless system clock and a network clock different from the wireless system clock where the network clock is adjustable based at least on the wireless system clock; determine one of a plurality of Propagation Delay (PD) compensation schemes for a first wireless device to implement based at least in part on at least one characteristic associated with the first wireless device, and indicate the one of the plurality of PD compensation schemes to the first wireless device for adjustment of the wireless system clock.

According to one or more embodiments, the adjustment of the wireless system clock is for use in performing a time stamping operation that measures a delay experienced when the network clock is relayed from a wireless system ingress point to a wireless system egress point where the measured delay is used for adjusting the network clock. The time stamping operation meets an accuracy requirement of the network clock. According to one or more embodiments, the processing circuitry is further configured to: determine a plurality of regions of a cell associated with the network node where the regions are defined based at least in part on at least one factor, and determine the first wireless device to be in one of the plurality of regions where the one of the plurality of PD compensation schemes determined for the first wireless device to implement is based on the determination that the first wireless device is in the one of the plurality of regions.

According to one or more embodiments, the at least one factor includes at least one of: a radial distance of coverage of the network node; a cell sector; at least one channel property; bandwidth part, BWP, of a carrier used to communicate with the first wireless device; first wireless device altitude; mobility rate of the first wireless device; mobility rate of the network node; and physical obstructions in the cell. According to one or more embodiments, the processing circuitry is further configured to select a delivery method for sending the wireless system clock to the first wireless device based at least on the determination that the first wireless device is in the one of the plurality of regions. According to one or more embodiments, the processing circuitry is further configured to: receive an indication of an accuracy requirement of the network clock to be met when relayed from a wireless system ingress point to a wireless system egress point; estimate a respective accuracy limitation of at least a subset of the plurality of PD compensation schemes; define a plurality of thresholds based at least in part on the respective accuracy limitation of at least the subset of the plurality of PD compensation schemes, each respective threshold of the plurality of thresholds being associated with a respective one of the plurality of PD compensation schemes, where the determination of the one of the plurality of PD compensation schemes for the first wireless device to implement is based on the accuracy limitation of the one of the plurality of PD compensation schemes meeting one of the plurality of thresholds that supports the accuracy requirement of the network clock.

According to one or more embodiments, the plurality of thresholds are defined based at least in part on at least one of the at least one factor. According to one or more embodiments, each of the at least one factor corresponds to a different one of the plurality of regions. According to one or more embodiments, the one of the plurality of PD compensation schemes determined for the first wireless device to implement is configured to reduce a signaling overhead and/or to reduce power consumption at the first wireless device when compared to at least one other of the plurality of PD compensation schemes.

According to one or more embodiments, the at least one characteristic associated with the first wireless device is a wireless device specific characteristic including at least one of: the first wireless device capability; a location of the first wireless device relative to the network node; transmission path estimation associated with the first wireless device; channel properties between the network node and the first wireless device; synchronization properties associated with at least one of the network node and first wireless device; and at least one wireless device operational requirement. According to one or more embodiments, the processing circuitry is further configured to: detect that a plurality of wireless devices have capability for side link communications; determine a group of the plurality of wireless devices that are within a predefined proximity to at least one other wireless device in the group where the group includes the first wireless device, and select the first wireless device to be a primary wireless device of the group where the primary wireless device is configured to send a PD value, associated with the indicated one of the plurality of PD compensation schemes determined for the first wireless device to implement, to the remaining wireless devices in the group for adjusting the wireless system clock.

According to one or more embodiments, the group includes at least one wireless device associated with a different accuracy requirement for the network clock than the other wireless devices in the group where the indicated one of the plurality of PD compensation schemes determined for the first wireless device to implement satisfies a strictest accuracy requirement of the different accuracy requirements for the network clock. According to one or more embodiments, the processing circuitry is further configured to determine the group based at least on each wireless device in the group having a same accuracy requirement of the network clock. According to one or more embodiments, the processing circuitry is further configured to determine that a difference in propagation delay for the wireless devices in the group is less than a predefined value.

According to one or more embodiments, the plurality of PD compensation schemes include at least one of a round trip time, RTT, based scheme, a non-RTT based scheme, zero PD compensation scheme and a side link based scheme. According to one or more embodiments, the wireless system clock is a 5^{th} Generation (5G) system clock and the network clock is a time-sensitive network, TSN, clock.

According to another aspect of the disclosure, a first wireless device for a wireless communication system is provided. The first wireless device includes processing circuitry configured to: receive a wireless system clock and a network clock different from the wireless system clock, the network clock being adjustable based at least on the wireless system clock; receive an indication of one of a plurality of Propagation Delay (PD) compensation schemes for the first wireless device to implement where the one of the plurality of PD compensation schemes is specific to the first wireless device based at least in part on at least one characteristic associated with the first wireless device, and adjust the wireless system clock using a PD value determined using the one of the plurality of PD compensation schemes.

According to one or more embodiments, the processing circuitry is further configured to: use the adjusted wireless system clock to perform a time stamping operation by measuring a delay experienced when the network clock is relayed from a wireless system ingress point to a wireless system egress point; and use the measured delay for adjusting the network clock, the adjusting of the network clock resulting in a network clock, at the wireless device, having a level of timing uncertainty within a predefined range relative to its grandmaster clock.

According to one or more embodiments, the one of the plurality of PD compensation schemes that is indicated to the first wireless device is based at least on the accuracy requirement of the network clock. According to one or more embodiments, the one of the plurality of PD compensation schemes determined for the first wireless device to implement is configured to reduce a signaling overhead and/or to reduce power consumption at the first wireless device when compared to at least one other of the plurality of PD compensation schemes. According to one or more embodiments, the at least one characteristic associated with the first wireless device is a wireless device specific characteristic including at least one of: the first wireless device capability; a location of the first wireless device relative to a network node; transmission path estimation associated with the first wireless device; channel properties between the network node and first wireless device; synchronization properties associated with at least one of the network node and first wireless device; and at least one wireless device operational requirement.

According to one or more embodiments, the processing circuitry is further configured to: indicate a capability for side link communications to a network node; receive an indication that the first wireless device has been selected as a primary wireless device of a group of a plurality of wireless devices that are within a predefined proximity to at least one other wireless device in the group; send a PD value, associated with the indication of one of the plurality of PD compensation schemes for the first wireless device to implement, to the remaining wireless devices in the group for adjusting the wireless system clock. According to one or more embodiments, the group includes at least one wireless device associated with a different accuracy requirement for the network clock than the other wireless devices in the group where the indicated one of the plurality of PD compensation schemes determined for the first wireless device to implement satisfies a strictest accuracy requirement of the different accuracy requirements for the network clock. According to one or more embodiments, the wireless devices in the group have a same accuracy requirement of the network clock.

According to one or more embodiments, a difference in propagation delay for the wireless devices in the group is less than a predefined value. According to one or more embodiments, the processing circuitry is configured to use side link message exchange to determine that at least one other wireless device in the group is within the predefined proximity. According to one or more embodiments, the plurality of PD compensation schemes include at least one of a round trip time, RTT, based scheme, a non-RTT based scheme, zero PD compensation scheme and a side link based scheme. According to one or more embodiments, the wireless system clock is a 5^{th} Generation (5G) system clock and the network clock is a time-sensitive network, TSN, clock.

According to another aspect of the disclosure, a method performed by a network node of a wireless communication system is provided. A wireless system clock and a network clock different from the wireless system clock are sent where the network clock is adjustable based at least on the wireless system clock. One of a plurality of Propagation Delay (PD) compensation schemes for a first wireless device to implement based at least in part on at least one characteristic associated with the first wireless device is determined. The one of the plurality of PD compensation schemes is indicated to the first wireless device for adjustment of the wireless system clock.

According to one or more embodiments, the adjustment of the wireless system clock is for use in performing a time stamping operation that measures a delay experienced when the network clock is relayed from a wireless system ingress point to a wireless system egress point where the measured delay is used for adjusting the network clock, where the time stamping operation meets an accuracy requirement of the network clock. According to one or more embodiments, a plurality of regions of a cell associated with the network node are determined where the regions are defined based at least in part on at least one factor. The first wireless device is determined to be in one of the plurality of regions where the one of the plurality of PD compensation schemes determined for the first wireless device to implement is based on the determination that the first wireless device is in the one of the plurality of regions. According to one or more embodiments, the at least one factor includes at least one of: a radial distance of coverage of the network node; a cell sector; at least one channel property; bandwidth part, BWP, of a carrier used to communicate with the first wireless device; first wireless device altitude; mobility rate of the first wireless device; mobility rate of the network node; and physical obstructions in the cell.

According to one or more embodiments, a delivery method for sending the wireless system clock to the first wireless device is selected based at least on the determination that the first wireless device is in the one of the plurality of regions. According to one or more embodiments, an indication of an accuracy requirement of the network clock to be met when relayed from a wireless system ingress point to a wireless system egress point is received. A respective accuracy limitation of at least a subset of the plurality of PD compensation schemes is estimated. A plurality of thresholds is defined based at least in part on the respective accuracy limitation of at least the subset of the plurality of PD compensation schemes where each respective threshold of the plurality of thresholds is associated with a respective one of the plurality of PD compensation schemes. The determination of the one of the plurality of PD compensation schemes for the first wireless device to implement is based on the accuracy limitation of the one of the plurality of PD compensation schemes meeting one of the plurality of thresholds that supports the accuracy requirement of the network clock. According to one or more embodiments, the plurality of thresholds are defined based at least in part on at least one of the at least one factor.

According to one or more embodiments, each of the at least one factor corresponds to a different one of the plurality of regions. According to one or more embodiments, the one of the plurality of PD compensation schemes determined for the first wireless device to implement is configured to reduce a signaling overhead and/or to reduce power consumption at the first wireless device when compared to at least one other of the plurality of PD compensation schemes. According to one or more embodiments, the at least one characteristic associated with the first wireless device is a wireless device specific characteristic including at least one of: the first wireless device capability; a location of the first wireless device relative to the network node; transmission path estimation associated with the first wireless device; channel properties between the network node and the first wireless device; synchronization properties associated with at least one of the network node and first wireless device; and at least one wireless device operational requirement.

According to one or more embodiments, a plurality of wireless devices are detected to have capability for side link communications. A group of the plurality of wireless devices that are within a predefined proximity to at least one other wireless device in the group is determined, where the group includes the first wireless device. The first wireless device is selected to be a primary wireless device of the group, where the primary wireless device is configured to send a PD value, associated with the indicated one of the plurality of PD compensation schemes determined for the first wireless device to implement, to the remaining wireless devices in the group for adjusting the wireless system clock. According to one or more embodiments, the group includes at least one wireless device associated with a different accuracy requirement for the network clock than the other wireless devices in the group where the indicated one of the plurality of PD compensation schemes determined for the first wireless device to implement satisfies a strictest accuracy requirement of the different accuracy requirements for the network clock. According to one or more embodiments, the group is determined based at least on each wireless device in the group having a same accuracy requirement of the network clock.

According to one or more embodiments, a difference in propagation delay for the wireless devices in the group is determined to be less than a predefined value. According to one or more embodiments, the plurality of PD compensation schemes include at least one of a round trip time, RTT, based scheme, a non-RTT based scheme, zero PD compensation scheme and a side link based scheme. According to one or more embodiments, the wireless system clock is a 5^{th} Generation (5G) system clock and the network clock is a time-sensitive network, TSN, clock.

According to another aspect of the disclosure, a method performed by a first wireless device of a wireless communication system is provided. A wireless system clock and a network clock different from the wireless system clock are received where the network clock is adjustable based at least on the wireless system clock. An indication of one of a plurality of Propagation Delay (PD) compensation schemes for the first wireless device to implement is received where the one of the plurality of PD compensation schemes is specific to the first wireless device based at least in part on at least one characteristic associated with the first wireless device. The wireless system clock is adjusted using a PD value determined using the one of the plurality of PD compensation schemes.

According to one or more embodiments, the adjusted wireless system clock is used to perform a time stamping operation by measuring a delay experienced when the network clock is relayed from a wireless system ingress point to a wireless system egress point. The measured delay is used for adjusting the network clock where the adjusting of the network clock results in a network clock, at the wireless device, having a level of timing uncertainty within a predefined range relative to its grandmaster clock. According to one or more embodiments, the one of the plurality of PD compensation schemes that is indicated to the first wireless device is based at least on the accuracy requirement of the network clock. According to one or more embodiments, the one of the plurality of PD compensation schemes determined for the first wireless device to implement is configured to reduce a signaling overhead and/or to reduce power consumption at the first wireless device when compared to at least one other of the plurality of PD compensation schemes.

According to one or more embodiments, the at least one characteristic associated with the first wireless device is a wireless device specific characteristic including at least one of: the first wireless device capability; a location of the first wireless device relative to a network node; transmission path estimation associated with the first wireless device; channel properties between the network node and first wireless device; synchronization properties associated with at least one of the network node and first wireless device; and at least one wireless device operational requirement. According to one or more embodiments, a capability for side link communications is indicated to a network node. An indication that the first wireless device has been selected as a primary wireless device of a group of a plurality of wireless devices that are within a predefined proximity to at least one other wireless device in the group is received. A PD value, associated with the indication of one of the plurality of PD compensation schemes for the first wireless device to implement, is sent to the remaining wireless devices in the group for adjusting the wireless system clock.

According to one or more embodiments, the group includes at least one wireless device associated with a different accuracy requirement for the network clock than the other wireless devices in the group where the indicated one of the plurality of PD compensation schemes determined for the first wireless device to implement satisfies a strictest accuracy requirement of the different accuracy requirements for the network clock. According to one or more embodiments, the wireless devices in the group have a same accuracy requirement of the network clock. According to one or more embodiments, a difference in propagation delay for the wireless devices in the group is less than a predefined value.

According to one or more embodiments, side link message exchange is used to determine that at least one other wireless device in the group is within the predefined proximity. According to one or more embodiments, the plurality of PD compensation schemes include at least one of a round trip time, RTT, based scheme, a non-RTT based scheme, zero PD compensation scheme and a side link based scheme. According to one or more embodiments, the wireless system clock is a 5^{th} Generation (5G) system clock and the network clock is a time-sensitive network, TSN, clock.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a schematic diagram of an exemplary network architecture illustrating a communication system connected via an intermediate network to a host computer according to the principles in the present disclosure;

FIG. 2 is a block diagram of a host computer communicating via a network node with a wireless device over an at least partially wireless connection according to some embodiments of the present disclosure;

FIG. 3 is a flowchart illustrating exemplary methods implemented in a communication system including a host computer, a network node and a wireless device for executing a client application at a wireless device according to some embodiments of the present disclosure;

FIG. 4 is a flowchart illustrating exemplary methods implemented in a communication system including a host computer, a network node and a wireless device for receiving user data at a wireless device according to some embodiments of the present disclosure;

FIG. 5 is a flowchart illustrating exemplary methods implemented in a communication system including a host computer, a network node and a wireless device for receiving user data from the wireless device at a host computer according to some embodiments of the present disclosure;

FIG. 6 is a flowchart illustrating exemplary methods implemented in a communication system including a host computer, a network node and a wireless device for receiving user data at a host computer according to some embodiments of the present disclosure;

FIG. 7 is a flowchart of an example process in a network node according to some embodiments of the present disclosure;

FIG. 8 is a flowchart of another example process in a network node according to some embodiments of the present disclosure;

FIG. 9 is a flowchart of an example process in a wireless device according to some embodiments of the present disclosure;

FIG. 10 is a flowchart of another example process in a wireless device according to some embodiments of the present disclosure;

FIG. 11 is a block diagram of a RTT based PD compensation scheme according to some embodiments of the present disclosure;

FIG. 12 is a flow diagram of a PD determination/selection flowchart according to some embodiments of the disclosure; and

FIG. 13 is a diagram of an offset timing advance.

### DETAILED DESCRIPTION

Before describing in detail exemplary embodiments, it is noted that the embodiments reside primarily in combinations of apparatus components and processing steps related to obtaining a propagation delay (PD) compensation scheme from among various PD compensation schemes based at least in part on at least one characteristic associated with the wireless device. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IOT) device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

As used herein, a 5^{th} Generation (5G, also referred to as New Radio (NR)) system clock may be referred to as a wireless system clock or internal system clock, being internal to the wireless communication system, such as the 5G system, in which case it may be denoted an internal 5G system clock or a 5G internal system clock. Although, the teachings described herein relate to a 5G clock, the teachings are equally applicable to other wireless communication systems and future wireless communication standards.

As used herein, a time-sensitive network (TSN) clock may be referred to as a network clock. The network clock may in some examples be an external network clock in that it may be generated at a source node or network node that is external to the wireless communication system, e.g. a 5G system. As an example, the TSN clock may be an external TSN clock, in that it is external to the wireless communication system, such as the 5G system.

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Embodiments provide obtaining a propagation delay (PD) compensation scheme from among various PD compensation schemes based at least in part on at least one characteristic associated with the wireless device.

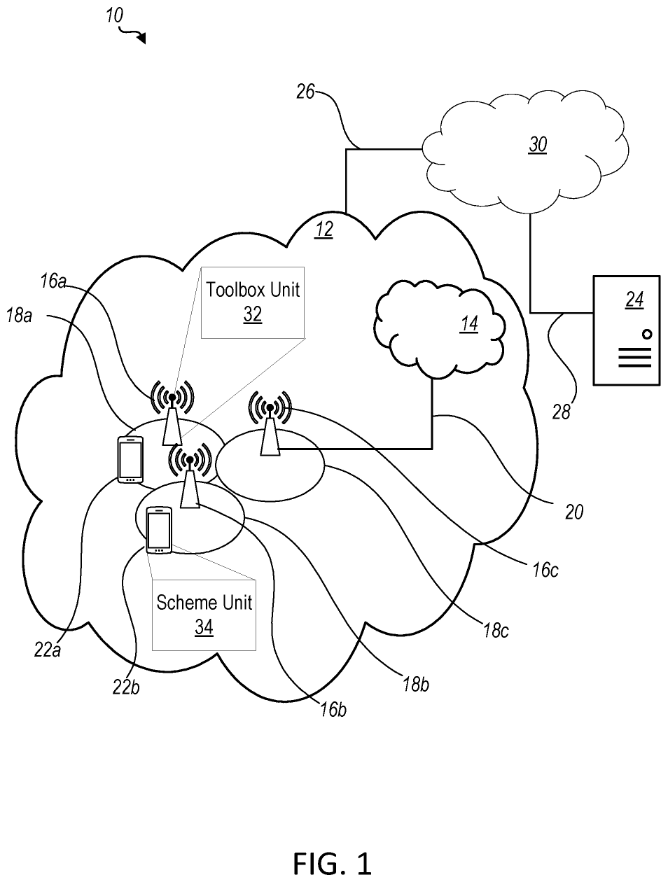

Referring now to the drawing figures, in which like elements are referred to by like reference numerals, there is shown in FIG. 1 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 1 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include a toolbox unit 32 which is configured to perform one or more network node 16 functions described herein such as with respect to obtaining and/or indicating a propagation delay (PD) compensation scheme from among various PD compensation schemes based at least in part on at least one characteristic associated with the wireless device. A wireless device 22 is configured to include a scheme unit 34 which is configured to perform one or more wireless device 22 functions as descried herein such as with respect to obtaining a propagation delay (PD) compensation scheme from among various PD compensation schemes based at least in part on at least one characteristic associated with the wireless device.

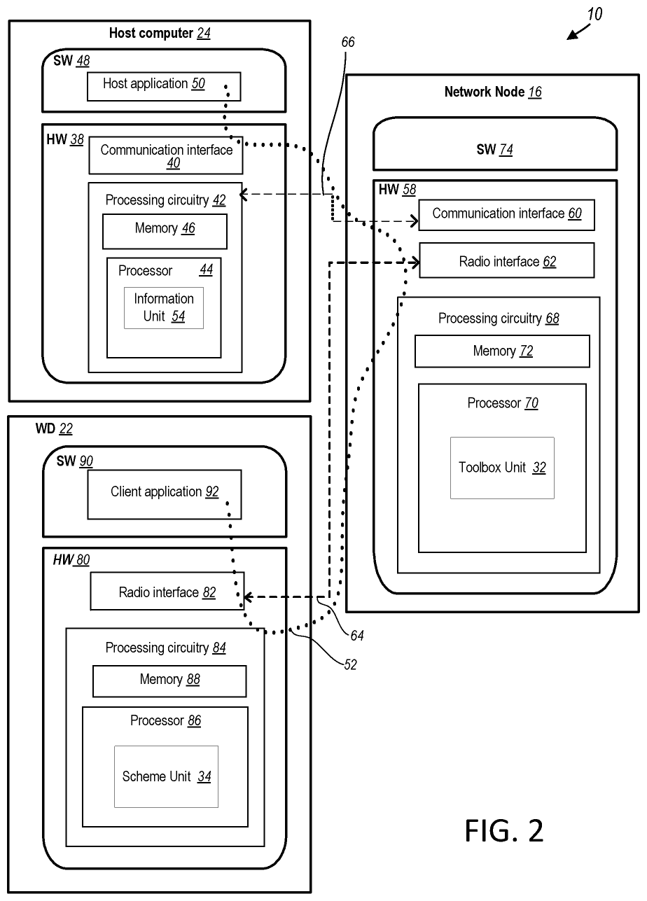

Example implementations, in accordance with an embodiment, of the WD 22, network node 16 and host computer 24 discussed in the preceding paragraphs will now be described with reference to FIG. 2. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22. The processing circuitry 42 of the host computer 24 may include an information unit 54 configured to enable the service provider to process, determine, select, forward, relay, transmit, receive, store, etc. information related to obtaining a propagation delay (PD) compensation scheme from among various PD compensation schemes based at least in part on at least one characteristic associated with the wireless device.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include toolbox unit 32 configured to perform one or more network node 16 functions described herein such as with respect to obtaining and/or indicating a propagation delay (PD) compensation scheme from among various PD compensation schemes based at least in part on at least one characteristic associated with the wireless device.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include a scheme unit 34 configured to perform one or more wireless device functions as described herein such as with respect to obtaining a propagation delay (PD) compensation scheme from among various PD compensation schemes based at least in part on at least one characteristic associated with the wireless device.

In some embodiments, the inner workings of the network node 16, WD 22, and host computer 24 may be as shown in FIG. 2 and independently, the surrounding network topology may be that of FIG. 1.

In FIG. 2, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 1 and 2 show various “units” such as toolbox unit 32, and scheme unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

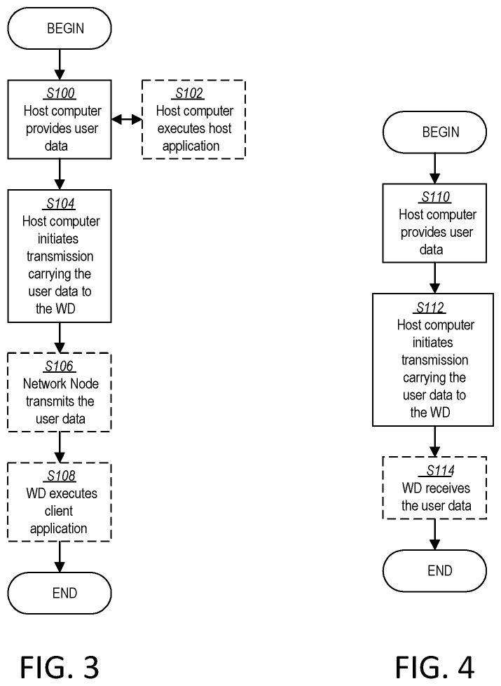

FIG. 3 is a flowchart illustrating an example method implemented in a communication system, such as, for example, the communication system of FIGS. 1 and 2, in accordance with one embodiment. The communication system may include a host computer 24, a network node 16 and a WD 22, which may be those described with reference to FIG. 2. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 4 is a flowchart illustrating an example method implemented in a communication system, such as, for example, the communication system of FIG. 1, in accordance with one embodiment. The communication system may include a host computer 24, a network node 16 and a WD 22, which may be those described with reference to FIGS. 1 and 2. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

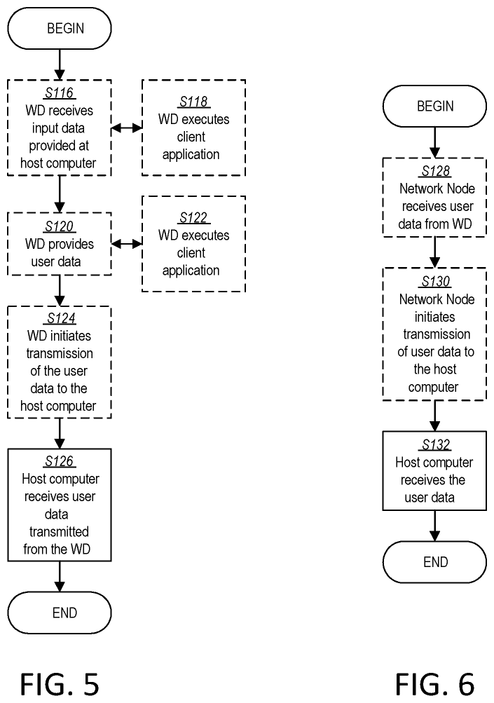

FIG. 5 is a flowchart illustrating an example method implemented in a communication system, such as, for example, the communication system of FIG. 1, in accordance with one embodiment. The communication system may include a host computer 24, a network node 16 and a WD 22, which may be those described with reference to FIGS. 1 and 2. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 6 is a flowchart illustrating an example method implemented in a communication system, such as, for example, the communication system of FIG. 1, in accordance with one embodiment. The communication system may include a host computer 24, a network node 16 and a WD 22, which may be those described with reference to FIGS. 1 and 2. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

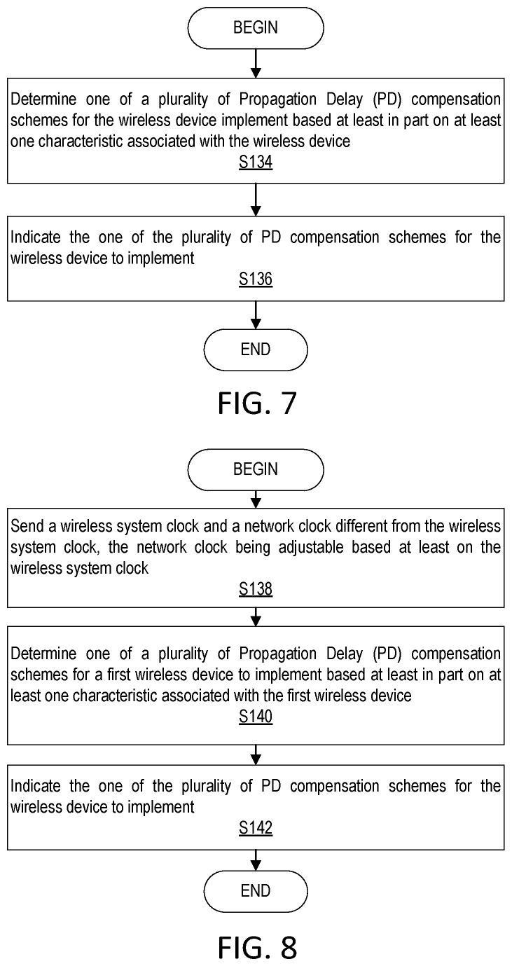

FIG. 7 is a flowchart of an example process in a network node 16 according to one or more embodiments of the disclosure. One or more Blocks and/or functions performed by network node 16 may be performed by one or more elements of network node 16 such as by toolbox unit 32 in processing circuitry 68, processor 70, radio interface 62, etc. In one or more embodiments, network node 16 such as via one or more of processing circuitry 68, processor 70, communication interface 60 and radio interface 62 is configured to determine (Block S134) one of a plurality of Propagation Delay (PD) compensation schemes for the wireless device 22 to implement based at least in part on at least one characteristic associated with the wireless device 22, as described herein. In one or more embodiments, network node 16 such as via one or more of processing circuitry 68, processor 70, communication interface 60 and radio interface 62 is configured to indicate (Block S136) the one of the plurality of PD compensation schemes for the wireless device to implement, as described herein.

FIG. 8 is a flowchart of another example process in a network node 16 according to one or more embodiments of the disclosure. One or more Blocks and/or functions performed by network node 16 may be performed by one or more elements of network node 16 such as by toolbox unit 32 in processing circuitry 68, processor 70, radio interface 62, etc. In one or more embodiments, network node 16 such as via one or more of processing circuitry 68, processor 70, communication interface 60 and radio interface 62 is configured to send (Block S138) a wireless system clock and a network clock different from the wireless system clock where the network clock is adjustable based at least on the wireless system clock, as described herein. In one or more embodiments, network node 16 such as via one or more of processing circuitry 68, processor 70, communication interface 60 and radio interface 62 is configured to determine (Block S140) one of a plurality of Propagation Delay (PD) compensation schemes for a first wireless device 22 to implement based at least in part on at least one characteristic associated with the first wireless device 22, as described herein. In one or more embodiments, network node 16 such as via one or more of processing circuitry 68, processor 70, communication interface 60 and radio interface 62 is configured to indicate (Block S142) the one of the plurality of PD compensation schemes to the first wireless device 22 for adjustment of the wireless system clock, as described herein.

According to one or more embodiments, the adjustment of the wireless system clock is for use in performing a time stamping operation that measures a delay experienced when the network clock is relayed from a wireless system ingress point to a wireless system egress point where the measured delay is used for adjusting the network clock. The time stamping operation meets an accuracy requirement of the network clock. According to one or more embodiments, the processing circuitry 68 is further configured to: determine a plurality of regions of a cell associated with the network node where the regions are defined based at least in part on at least one factor, and determine the first wireless device 22 to be in one of the plurality of regions where the one of the plurality of PD compensation schemes determined for the first wireless device 22 to implement is based on the determination that the first wireless device 22 is in the one of the plurality of regions.

According to one or more embodiments, the at least one factor includes at least one of: a radial distance of coverage of the network node 16; a cell sector; at least one channel property; bandwidth part, BWP, of a carrier used to communicate with the first wireless device 22; first wireless device 22 altitude; mobility rate of the first wireless device 22; mobility rate of the network node 16; and physical obstructions in the cell. According to one or more embodiments, the processing circuitry 68 is further configured to select a delivery method for sending the wireless system clock to the first wireless device 22 based at least on the determination that the first wireless device 22 is in the one of the plurality of regions. According to one or more embodiments, the processing circuitry 68 is further configured to: receive an indication of an accuracy requirement of the network clock to be met when relayed from a wireless system ingress point to a wireless system egress point; estimate a respective accuracy limitation of at least a subset of the plurality of PD compensation schemes; define a plurality of thresholds based at least in part on the respective accuracy limitation of at least the subset of the plurality of PD compensation schemes, each respective threshold of the plurality of thresholds being associated with a respective one of the plurality of PD compensation schemes, where the determination of the one of the plurality of PD compensation schemes for the first wireless device 22 to implement is based on the accuracy limitation of the one of the plurality of PD compensation schemes meeting one of the plurality of thresholds that supports the accuracy requirement of the network clock.

According to one or more embodiments, the plurality of thresholds are defined based at least in part on at least one of the at least one factor. According to one or more embodiments, each of the at least one factor corresponds to a different one of the plurality of regions. According to one or more embodiments, the one of the plurality of PD compensation schemes determined for the first wireless device 22 to implement is configured to reduce a signaling overhead and/or to reduce power consumption at the first wireless device when compared to at least one other of the plurality of PD compensation schemes.

According to one or more embodiments, the at least one characteristic associated with the first wireless device 22 is a wireless device specific characteristic including at least one of: the first wireless device 22 capability; a location of the first wireless device 22 relative to the network node 16; transmission path estimation associated with the first wireless device 22; channel properties between the network node 16 and the first wireless device 22; synchronization properties associated with at least one of the network node 16 and first wireless device 22; and at least one wireless device operational requirement. According to one or more embodiments, the processing circuitry 68 is further configured to: detect that a plurality of wireless devices 22 have capability for side link communications; determine a group of the plurality of wireless devices 22 that are within a predefined proximity to at least one other wireless device 22 in the group where the group includes the first wireless device, and select the first wireless device 22 to be a primary wireless device 22 of the group where the primary wireless device 22 is configured to send a PD value, associated with the indicated one of the plurality of PD compensation schemes determined for the first wireless device 22 to implement, to the remaining wireless devices 22 in the group for adjusting the wireless system clock.

According to one or more embodiments, the group includes at least one wireless device 22 associated with a different accuracy requirement for the network clock than the other wireless devices 22 in the group where the indicated one of the plurality of PD compensation schemes determined for the first wireless device 22 to implement satisfies a strictest accuracy requirement of the different accuracy requirements for the network clock. The strictest accuracy requirement of the different accuracy requirements may in one example be a strictest accuracy requirement for all of a number of network clocks of interest to the first wireless device 22. According to one or more embodiments, the processing circuitry 68 is further configured to determine the group based at least on each wireless device 22 in the group having a same accuracy requirement of the network clock. According to one or more embodiments, the processing circuitry 68 is further configured to determine that a difference in propagation delay for the wireless devices 22 in the group is less than a predefined value. For example, this may mean that the processing circuitry 68 is configured to determine that the difference in propagation delay for transmissions from or to the network node 16 between any two wireless devices 22 in the group is less than the predefined value. In one example, it means that the processing circuitry 68 is configured to determine that each wireless device 22 in the group has a propagation delay difference relative to the primary wireless device 22 that is less than the predefined value.

According to one or more embodiments, the plurality of PD compensation schemes include at least one of a round trip time, RTT, based scheme, a non-RTT based scheme, zero PD compensation scheme and a side link based scheme. According to one or more embodiments, the wireless system clock is a 5^{th} Generation (5G) system clock and the network clock is a time-sensitive network, TSN, clock.

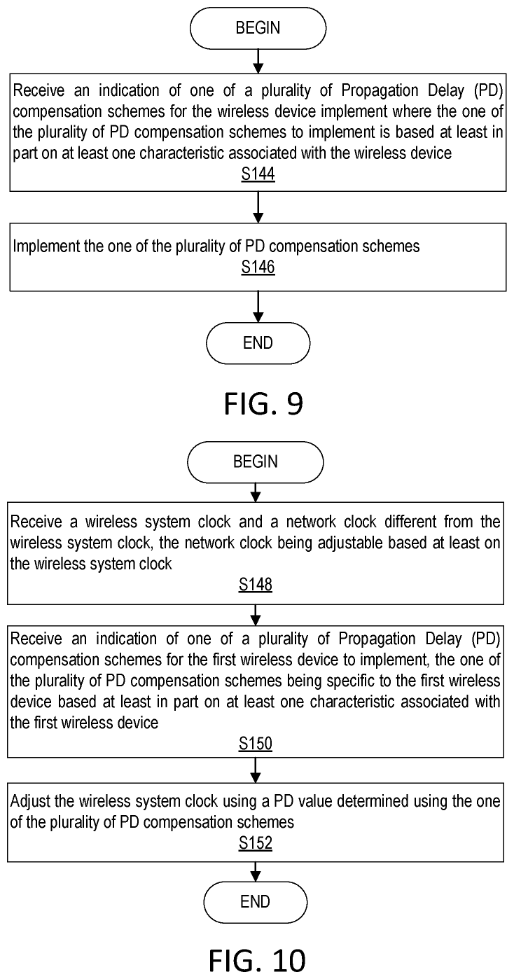

FIG. 9 is a flowchart of an example process in a wireless device 22 according to some embodiments of the present disclosure. One or more Blocks and/or functions performed by wireless device 22 may be performed by one or more elements of wireless device 22 such as by scheme unit 34 in processing circuitry 84, processor 86, radio interface 82, etc. In one or more embodiments, wireless device such as via one or more of processing circuitry 84, processor 86 and radio interface 82 is configured to receive (Block S144) an indication of one of a plurality of Propagation Delay (PD) compensation schemes for the wireless device 22 implement where the one of the plurality of PD compensation schemes to implement is based at least in part on at least one characteristic associated with the wireless device 22, as described herein. In one or more embodiments, wireless device 22 such as via one or more of processing circuitry 84, processor 86 and radio interface 82 is configured to implement (Block S146) the one of the plurality of PD compensation schemes, as described herein.

FIG. 10 is a flowchart of another example process in a wireless device 22 according to some embodiments of the present disclosure. One or more Blocks and/or functions performed by wireless device 22 may be performed by one or more elements of wireless device 22 such as by scheme unit 34 in processing circuitry 84, processor 86, radio interface 82, etc. In one or more embodiments, first wireless device 22 such as via one or more of processing circuitry 84, processor 86 and radio interface 82 is configured to receive (Block S148) a wireless system clock and a network clock different from the wireless system clock where the network clock is adjustable based at least on the wireless system clock, as described herein. In one or more embodiments, first wireless device 22 such as via one or more of processing circuitry 84, processor 86 and radio interface 82 is configured to receive (Block S150) an indication of one of a plurality of Propagation Delay (PD) compensation schemes for the first wireless device 22 to implement where the one of the plurality of PD compensation schemes is specific to the first wireless device 22 based at least in part on at least one characteristic associated with the first wireless device 22, as described herein. In one or more embodiments, first wireless device 22 such as via one or more of processing circuitry 84, processor 86 and radio interface 82 is configured to adjust (Block S152) the wireless system clock using a PD value determined using the one of the plurality of PD compensation schemes, as described herein.

According to one or more embodiments, the processing circuitry 84 is further configured to: use the adjusted wireless system clock to perform a time stamping operation by measuring a delay experienced when the network clock is relayed from a wireless system ingress point to a wireless system egress point; and use the measured delay for adjusting the network clock, the adjusting of the network clock resulting in a network clock, at the wireless device, having a level of timing uncertainty within a predefined range relative to its grandmaster clock. According to one or more embodiments, the one of the plurality of PD compensation schemes that is indicated to the first wireless device 22 is based at least on the accuracy requirement of the network clock. According to one or more embodiments, the one of the plurality of PD compensation schemes determined for the first wireless device 22 to implement is configured to reduce a signaling overhead and/or to reduce power consumption at the first wireless device 22 when compared to at least one other of the plurality of PD compensation schemes.

According to one or more embodiments, the at least one characteristic associated with the first wireless device 22 is a wireless device specific characteristic including at least one of: the first wireless device 22 capability; a location of the first wireless device 22 relative to a network node 16; transmission path estimation associated with the first wireless device 22; channel properties between the network node 16 and first wireless device 22; synchronization properties associated with at least one of the network node 16 and first wireless device 22; and at least one wireless device 22 operational requirement. According to one or more embodiments, the processing circuitry 84 is further configured to: indicate a capability for side link communications to a network node 16; receive an indication that the first wireless device 22 has been selected as a primary wireless device 22 of a group of a plurality of wireless devices 22 that are within a predefined proximity to at least one other wireless device 22 in the group; send a PD value, associated with the indication of one of the plurality of PD compensation schemes for the first wireless device 22 to implement, to the remaining wireless devices 22 in the group for adjusting the wireless system clock. According to one or more embodiments, the group includes at least one wireless device 22 associated with a different accuracy requirement for the network clock than the other wireless devices 22 in the group where the indicated one of the plurality of PD compensation schemes determined for the first wireless device 22 to implement satisfies a strictest accuracy requirement of the different accuracy requirements for the network clock. The strictest accuracy requirement of the different accuracy requirements may in one example be a strictest accuracy requirement for all of a number of network clocks of interest to the first wireless device 22.

According to one or more embodiments, the wireless devices 22 in the group have a same accuracy requirement of the network clock. According to one or more embodiments, a difference in propagation delay for the wireless devices 22 in the group is less than a predefined value. For example, this may mean that the difference in propagation delay for transmissions from or to the network node 16 between any two wireless devices 22 in the group is less than the predefined value. In one example, it means that each wireless device 22 in the group has a propagation delay difference relative to the primary wireless device 22 that is less than the predefined value. According to one or more embodiments, the processing circuitry 84 is configured to use side link message exchange to determine that at least one other wireless device 22 in the group is within the predefined proximity.

According to one or more embodiments, the plurality of PD compensation schemes include at least one of a round trip time, RTT, based scheme, a non-RTT based scheme, zero PD compensation scheme and a side link based scheme. According to one or more embodiments, the wireless system clock is a 5^{th} Generation (5G) system clock and the network clock is a time-sensitive network, TSN, clock.

Having generally described arrangements for obtaining and/or indicating a propagation delay (PD) compensation scheme from among various PD compensation schemes based at least in part on at least one characteristic associated with the wireless device, details for these arrangements, functions and processes are provided as follows, and which may be implemented by the network node 16, wireless device 22 and/or host computer 24.

Embodiments provide for obtaining and/or indicating a propagation delay (PD) compensation scheme from among various PD compensation schemes based at least in part on at least one characteristic associated with the wireless device 22.

Different forms of PD methods can be used.

RTT Based Method/Process (Method 1)

A general method is a Round Trip Time (RTT) measurement where time stamping is performed at the participating network nodes 16 and

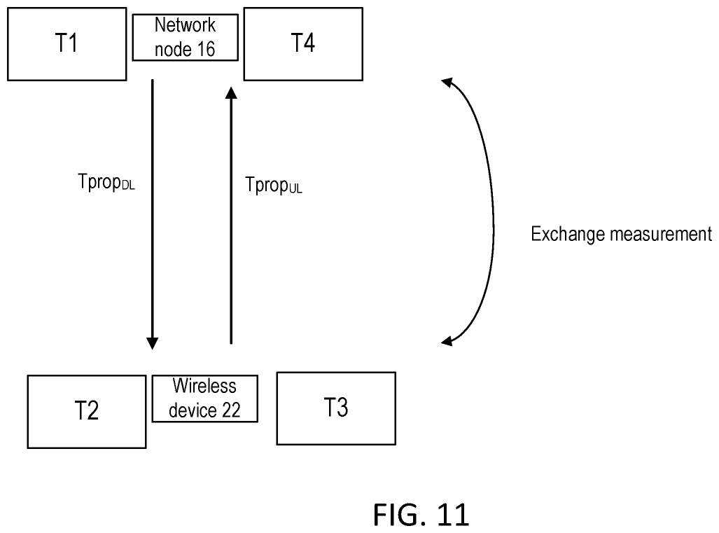

PD=((T4−T1)−(T3−T2))/2, as illustrated in FIG. 11 that shows RTT based PD compensation.

Existing 3GPP TA is one variant of an RTT method with somewhat different purpose, i.e., to align wireless device 22 uplink transmission at the network node 16 receiver independent RF uplink propagation time (by advancing wireless device uplink transmission so that the network node 16 receiver experiences a nominal alignment of uplink system frame reception relative to downlink system frame transmission).

Some common error sources include:
Channel asymmetries in DL and UL (since the 5GS clock (i.e., wireless system clock) is transmitted in the DL direction, asymmetries towards UL direction may introduce errors). TDD generally has better symmetries than FDD. A wireless device 22 can also be TSN GM and could go in opposite direction (actually in both directions if wireless device to wireless device over two Uu interfaces)
Resolution in exchange of timing measurements
Internal errors in network node 16/wireless device 22 relative timing between Receive and Transmit (e.g., wireless device 22 specified Te in wireless communication standards such as 3GPP TS 38.133)
   Where distribution of internal error in TX and RX paths could cause asymmetries similar to channel asymmetry errors.
Time stamp accuracies which has a dependency towards reference signal BW, received SNR, channel delay spread and specific implementation characteristics.

Non-RTT Based Method/Process (Method 2)

Other forms of PD compensation may build upon using a common delay offset information for a group of wireless devices 22. Using such an arrangement, wireless devices 22 such as via one or more of processing circuitry 84, processor 86, radio interface 82, scheme unit 34, etc., may able to reduce their maximum PD error. For example, if the delay offset is based on a wireless device 22 distance of R/2 from the cell antenna, the maximum PD error in for the cell with radius R=60 m reduces to half, i.e., 100 ns instead of not doing any compensation (200 ns). Since the required delay offset information is common for a group of wireless devices 22, the compensation could be performed through more resource efficient broadcast signaling. Such methods can be applied commonly to group of wireless devices 22.

RTT measurements could in some cases be more accurate, however, the realization of such methods may involve an additional complexity and system overhead. The accuracy and resolution for a RTT based method with error sources mentioned above might still not be enough to justify its use for some cells or actual propagation distances below a certain threshold, dependent on estimated accuracy of the RTT based method (e.g., if error it introduces is larger than propagation time within cell).

In one or more embodiments, a wireless device 22 such as for example via one or more of processing circuitry 84, processor 86, radio interface 82, scheme unit 34, etc., can perform this SIB based method of PD compensation upon detecting the necessary information as part of a SIB transmission. However, if the network node 16 such as for example via one or more of processing circuitry 68, processor 70, radio interface 62, toolbox unit 32, etc., subsequently triggers communication with the wireless device 22 per the RTT based method (method 1), the wireless device 22 may overwrite the current (method 2 based) PD compensation value with the PD compensation value determined using method 1, i.e., the wireless device 22 may dynamically update, modify and/or change the PD compensation value.

Similarly, if the wireless device 22 such as for example via one or more of processing circuitry 84, processor 86, radio interface 82, scheme unit 34, etc. performs this SIB based method of PD compensation and subsequently receives a value for PD compensation using the side link method (method 3, described below), the wireless device 22 may overwrite the current (method 2 based) PD compensation value with the PD compensation value determined using method 3, i.e., the wireless device 22 may dynamically update, modify and/or change the PD compensation value.

Side Link Based Method/Process (Method 3)

This method focuses at least in part on using the side link communication path for delivering propagation delay compensation for 5GS time (5GS clock value) from a master wireless device 22 to slave wireless devices 22. This method may be of interest and/or preferred whenever (a) performing PD compensation is of value due to accuracy requirements for external TSN clocks and cell radius exceeding a threshold value and/or (b) radio interface traffic being high enough to justify enabling radio interface load mitigation techniques, i.e., when one or more conditions and/or at least one criterion are met. Some aspects of this method are as follows:
The network node 16 such as for example via one or more of processing circuitry 68, processor 70, radio interface 62, toolbox unit 32, etc., can detect when a wireless device 22 such as for example via one or more of processing circuitry 84, processor 86, radio interface 82, scheme unit 34, etc. supports the side link based PD compensation method, e.g., as a result of the RRC signaling performed when a wireless device 22 first enters the RRC_Connected mode. For example, the RRCSetupRequest message sent by a wireless device 22 to the network node 16 to trigger wireless device 22 entry into RRC_Connected mode could be enhanced to include a new indicator, indicating the wireless device 22 supports side link based PD compensation method. This may allow a network node 16 such as for example via one or more of processing circuitry 68, processor 70, radio interface 62, toolbox unit 32, etc., to use the side link-based PD compensation method when conditions (a) and/or (b) above are satisfied.
at least one of a plurality of wireless devices 22 such as for example via one or more of processing circuitry 84, processor 86, radio interface 82, scheme unit 34, etc. supporting the side link based method and that are in close proximity and estimated to have similar RF propagation delay (e.g., a few meters) can be configured to be part of the same side link group (i.e., they are configured with the same side link group ID).
Configuration can be through RRC configuration or through self-discovery wherein a set of N wireless devices 22 use side link message exchanges to determine they are in close physical proximity.
The network node 16 such as for example via one or more of processing circuitry 68, processor 70, radio interface 62, toolbox unit 32, etc., can select one wireless device 22 in the same side link group as the primary wireless device 22 and perform a PD compensation method with that wireless device 22 (e.g., using a RTT based method per method 1 above).
The network node 16 such as for example via one or more of processing circuitry 68, processor 70, radio interface 62, toolbox unit 32, etc., performs PD compensation method 1 periodically with the primary wireless device or, e.g., whenever it the detects UL SFN transmissions from the master wireless device 22 as being received with unacceptable accuracy with respect to the nominal window of reception.
Once the primary wireless device 22 such as for example via one or more of processing circuitry 84, processor 86, radio interface 82, scheme unit 34, etc. establishes a value for the PD compensation, the primary wireless device 22 uses the value to adjust the 5G system time it receives from the network node 16, thereby enabling the wireless device 22 such as for example via one or more of processing circuitry 84, processor 86, radio interface 82, scheme unit 34, etc. to use the adjusted 5G system time (i.e., wireless system clock) for a timestamp based method to determine the time it takes for an external TSN clock (i.e., network clock) to transit the 5G system (e.g., the residence time from the UPF/TT to the wireless device/TT) such as to allow for adjustment of the TSN clock.
The primary wireless device 22 such as for example via one or more of processing circuitry 84, processor 86, radio interface 82, scheme unit 34, etc. can use side link to send the PD compensation value to all other wireless devices 22 in the group thereby enabling them to adjust all received external TSN clocks of interest (i.e., received within gPTP sync messages) according to the received PD compensation value to thereby establishing current values for these external TSN clocks. The adjustment is based on the 5G residence time experienced by the gPTP sync message which is measured using the ingress timestamp and egress timestamp of the gPTP sync message (carrying the external TSN clock) sent through the 5G system. All wireless devices 22 may use the PD compensation value to establish an updated value for the 5G system clock which is then used to perform the egress timestamping function at the wireless device/TT.

PD Compensation Toolbox EXAMPLES

Below is the list of some examples that can be utilized

a. alone or

b. in combination.

Example 1. To compensate PD for wireless devices 22 in a cell. The cell, e.g., coverage area 18, can be divided into different regions (e.g., concentric regions, sectors) and where wireless devices 22 from each region is applied is carefully selected the PD compensation. Some PD compensation parameters can be common to the wireless devices 22 in the region and therefore, those parameters can be broadcasted in the region. This helps in minimizing the required signaling overhead.
a. One example of different of utilization different PD compensation methodologies is,
   i. For nearby wireless devices 22 (with respect to cell center), no PD compensation is needed,
   ii. For wireless devices 22 at a moderate distance, the PD compensation based on one or more existing methods.
      1. Hence, the wireless devices 22 which are in this region receive some broadcasted parameters (e.g., the radius of the cell), not broadcasted in the whole cell, but broadcasted in the specific region (this is equivalent to multicasting if the whole cell is being considered).
   iii. For wireless device 22s at a large distance, the PD compensation based on some existing methods such as those that may be described herein (or advanced TA/RTT based) can be applied.
b. In one example, the PD compensation methodology can be the same for different regions, but their periodicity can be different (the range can be from none, to low, to moderate, to high).
   i. E.g., all regions utilize TA procedure for PD compensation, however the nearby wireless devices 22 to the network node 16 can have lower periodicity of TA procedure (it may go down to zero, which means TA is not applied at all) whereas the farthest wireless device 22 from the network node 16 are scheduled with maximal periodicity for TA procedure (TA procedure is very repetitive in time-domain)
   ii. The wireless devices 22 which are closer to cell and where a PD compensation may produce more synchronization errors than without applying it, then PD compensation method may be considered for the region, and this is equivalent to PD procedure with zero periodicity
c. The different regions in the cell can be based on at least one of a plurality of factors, where the factors may include one or more of:
   i. Radial distance
   ii. Cell sector
   iii. Channel properties
   iv. BWP
   v. Wireless device 22 height
   vi. Physical obstacles presence
   vii. Mobility rate of the wireless device 22
   viii. Network node 16 mobility
d. The PD compensation procedure can include at the least two components
   i. The PD compensation technique, e.g., non-/RTT based, side link based
   ii. 5GS clock delivery.

Different PD compensation procedures do not necessarily have different PD compensation techniques, they can be differentiated based on 5GS clock (i.e., wireless system clock) delivery method alone as well, for example, for different regions, the 5GS clock delivery can have different occasions or periodicity.

Example 2. Wireless devices 22 belonging to a same service may have single E2E time synch target (which includes an error in at least one of OTA, core network, etc.), e.g., maximum E2E 1 us synchronization error. However, for the OTA, different regions can exhibit different PD properties (e.g., due to factors mentioned above in 1c). Hence, different regions may have different PD compensation needs; and, a suitable method is required to identify the regions. Various methods by which a cell can identify the regions' compensation application are described.
a) Approximate RTT measurement: Different wireless device 22s such as for example via one or more of processing circuitry 84, processor 86, radio interface 82, scheme unit 34, etc. can perform some RTT measurement (e.g., with TA procedure), where the network node 16 such as for example via one or more of processing circuitry 68, processor 70, radio interface 62, toolbox unit 32, etc., can determine the approximate location of the wireless devices 22 in the cell. Then these wireless devices 22 can be grouped into different regions (RTT/radial-distance based) and therefore cell can choose different PD compensation methods for different regions
b) Wireless device 22's proximity: In this method, wireless device 22 such as for example via one or more of processing circuitry 84, processor 86, radio interface 82, scheme unit 34, etc. determines the proximity.
   i) Sidelink based communications allows a method by which a set of wireless devices 22 such as for example via one or more of processing circuitry 84, processor 86, radio interface 82, scheme unit 34, etc. can determine that they are in close physical proximity (e.g., no more than 5 m apart) where the wireless devices 22 in close physical proximity to each other have similar or the same RF propagation delay when receiving the 5G system clock from the network node 16.
   ii) Sidelink signaling allows for one wireless device 22 in the set to be identified as the primary wireless device 22 and this wireless device 22 can then indicate to the network node 16 that it requires determination of the 5G system clock (i.e., wireless system clock) with high precision (i.e., for the case where uncertainty associated with external TSN clocks is to be kept very low, i.e., accuracy requirement for TSN clocks, i.e., network clocks)
   iii) This may signify or mean that the network node 16 may need to perform a PD compensation procedure (e.g., method 1) with the primary wireless device 22 to establish a value for PD compensation but does not do so for all other wireless devices 22 in the set (i.e., since they do not indicate they require determination of the 5G system clock with high precision).
   iv) The delivery of the 5G system clock to the primary wireless device 22 such as for example via one or more of processing circuitry 84, processor 86, radio interface 82, scheme unit 34, etc. can be supported using RRC unicast or SIB based delivery and can occur before and/or after the network node 16 performs a PD compensation procedure with that wireless device 22.
   v) The primary wireless device 22 such as for example via one or more of processing circuitry 84, processor 86, radio interface 82, scheme unit 34, etc. uses the applicable downlink PD to adjust its value for the external TSN clocks of interest accordingly (e.g., the applicable downlink PD is used to adjust the 5G system clock of the primary wireless device, thereby allowing the adjusted 5G system clock to be used for a timestamping based method for determining the 5G residence experienced when an external TSN clock is sent through the 5G system to the primary wireless device 22).
   vi) The primary wireless device 22 such as for example via one or more of processing circuitry 84, processor 86, radio interface 82, scheme unit 34, etc. informs at least one of a plurality of other wireless devices 22 in the set of close physical proximity wireless devices 22 about the applicable downlink PD compensation and the at least one of the plurality of other wireless devices 22 adjust their values for the external TSN clocks accordingly. The adjustment may be based at least in part on the 5G residence time experienced by the gPTP sync message which is measured using the ingress timestamp and egress timestamp of the gPTP sync message (carrying the external TSN clock) sent through the 5G system. All wireless devices 22 use the PD compensation value to establish an updated value for the 5G system clock which is then used to perform the egress timestamping function at the wireless device/TT.
   vii) The non-primary wireless devices 22 in the set can receive the external TSN clocks in the same way that the primary wireless device 22 does (i.e. by receiving gPTP sync messages delivered as payload between the UPF/TT to the wireless device/TT).
   viii) The greater the number of non-primary wireless devices 22 in the set the greater the savings in radio interface signaling bandwidth since these wireless devices 22 may not need to perform a PD compensation procedure (e.g., method 1) with the network node 16 to allow the wireless devices 22 to determine the value of the 5G system clock with high precision, i.e., within a predefined of accuracy error. In other words, a non-primary wireless device 22 such as for example via one or more of processing circuitry 84, processor 86, radio interface 82, scheme unit 34, etc. can use the PD compensation value received from the primary wireless device 22 to adjust its 5G system clock, thereby allowing the adjusted 5G system clock to be used for a timestamping based method for determining the 5G residence experienced when an external TSN clock is sent through the 5G system to a non-primary wireless device 22).
c) RF Path loss estimation
d) Various existing positioning-based methods to localize the wireless device 22, e.g., GNSS based, variants of Time Difference Of Arrival (TDOA), Angle of Arrival (AoA), fingerprinting, etc.

Example 3. The estimated accuracy of an RTT based method (the same or similar to Example 1a (iii) described above) may decide the border between the regions in Example 1 described above. For example, if an RTT based method targets an estimated accuracy limitation of 200 ns (i.e., accuracy limitation of the PD method (PD compensation scheme)) when performing PD compensation, this 200 ns corresponds to ˜60 m air propagation, and gives a border for the region where a RTT could be considered. The estimate of the RTT accuracy could be based on at least one of the plurality of the following:
e) Wireless device 22 timing characteristics (relative TX/RX errors, internal asymmetries, etc.), e.g., indicated through capability signaling
f) BS timing characteristics (relative TX/RX errors, internal asymmetries, etc.)
g) RTT method used includes resolution in signaling for exchanging timing data
h) Characteristics of reference signals used such as timing characteristics and BW
i) Channel properties such as delay spread and received SNR

Example 4. The method used for PD compensation in addition to above may depend on the strictest required TSN end device accuracy (i.e., accuracy requirement of the network clock) that the wireless device 22 may need to serve. That is, in one example, the PD compensation used by wireless device 22 acting as a master device is determined based on a strictest accuracy requirement for the TSN clock among the wireless devices 22 in the group where at least one wireless device 22 in the group has a different TSN clock accuracy requirement than at least one other wireless device 22 in the group. If a wireless device 22 only serves TSN end devices that have a less accurate end to end timing accuracy towards its TSN Grandmaster (GM) clock then one can assume a more relaxed budget for the 5GS synchronicity between network node 16 and wireless device 22. As an example a wireless device 22 having a RF propagation distance of 300 m (corresponding to a PD of 1 us), if the wireless device 22 serves TSN end devices with a strictest total TSN e2e uncertainty requirement (i.e., accuracy requirement of the network clock) of 1 us an accurate PD method may be needed (since the radio interface is only allowed to consume a small fraction of e2e uncertainty budget) while if the wireless device 22 only serves TSN end devices with a 50 us E2E uncertainty requirement (i.e., accuracy requirement of the network clock) there might not be any need for a PD compensation at all or only a simpler form of PD compensation.

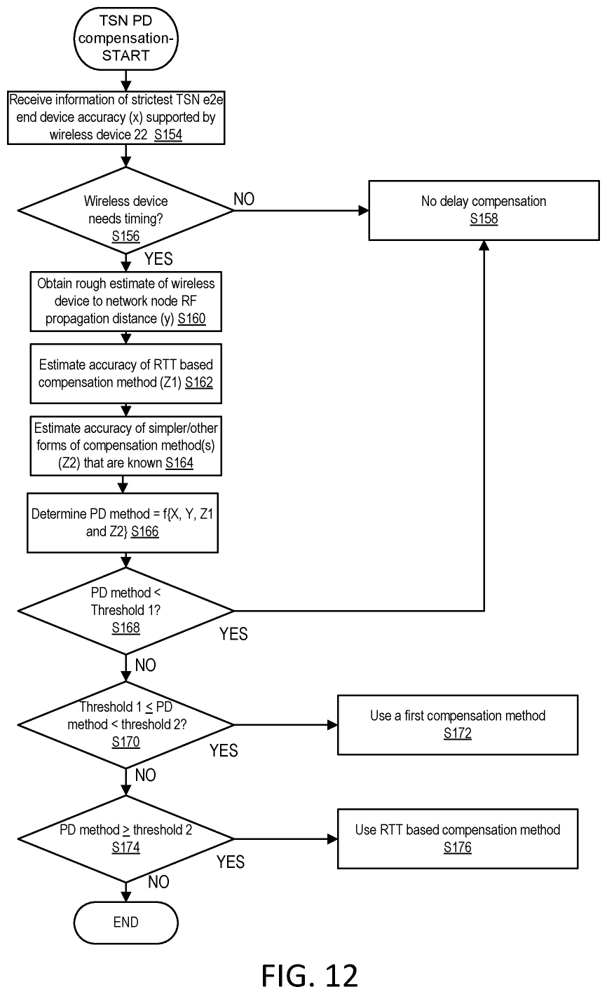

Example 5. An algorithm that describes one or more embodiments of present disclosure are presented below:
j) Network node 16 such as for example via one or more of processing circuitry 68, processor 70, radio interface 62, toolbox unit 32, etc., gathers information related to wireless devices 22, their link properties (e.g., channel, etc.), wireless device 22 set properties, synchronization target properties, OTA Uu budget for allowed time synchronization error (uncertainty), 5GS time delivery, etc.
k) Network node 16 such as for example via one or more of processing circuitry 68, processor 70, radio interface 62, toolbox unit 32, etc., divides wireless devices 22 into logical groups based at least in part on the required PD compensation procedure for the wireless devices 22.
   i) Examples of different compensation techniques are RTT, non-RTT, side link based, or based on PD compensation periodicity, or 5GS clock delivery procedure associated with a PD compensation. Further, “not applying” any PD compensation procedure can be classified and/or interpreted as one of the procedures. For example, in one or more embodiments, not applying PD compensation may be considered a compensation technique since not applying PD compensation may provide better performance or a better PD than apply a PD compensation technique that results in worst performance or worst PD.
   ii) To divide wireless devices 22 into logical groups and correspondingly select appropriate PD compensation procedure, network node 16 such as for example via one or more of processing circuitry 68, processor 70, radio interface 62, toolbox unit 32, etc., may need to define threshold(s) that serve as the basis for establishing how to identify the PD applicable to different wireless devices 22 or identifying the logical groups that wireless devices 22 can be separated into.
      (1) The thresholds can be devised based on factors, e.g., discussed in 1c.
      (2) For e.g., wireless devices 22 that satisfy threshold tₐ may apply PD compensation procedure pₐ, the wireless devices 22 that satisfy threshold t_{b} may apply PD compensation procedure p_{b}, so on.
   iii) FIG. 12 is a flow chart for PD determination according to one or more embodiments of the disclosure. One or more blocks in the flowchart may be implemented by, for example, one or more of processing circuitry 68, processor 70, radio interface 62, toolbox unit 32, etc. For example, in one or more embodiments, network node 16 such as via one or more of processing circuitry 68, processor 70, communication interface 60 and radio interface 62 is configured to receive (Block S154) information of a strictest TSN e2e (also referred to as E2E or end-to-end) end device accuracy (x) supported by wireless device 22, as described herein. In one or more embodiments, network node 16 such as via one or more of processing circuitry 68, processor 70, communication interface 60 and radio interface 62 is configured to a determination (Block S156) is made whether wireless device 22 needs timing, as described herein. If no timing is needed, no delay compensation on the 5G system clock (i.e., wireless system clock) is performed. If timing is needed for the wireless device 22, in one or more embodiments, network node 16 such as via one or more of processing circuitry 68, processor 70, communication interface 60 and radio interface 62 is configured to obtain (Block S160) a rough estimate of wireless device 22 to network node 16 RF propagation distance (y), as described herein. In one or more embodiments, network node 16 such as via one or more of processing circuitry 68, processor 70, communication interface 60 and radio interface 62 is configured to estimate (Block S162) accuracy of RTT based compensation method (Z1). In one or more embodiments, network node 16 such as via one or more of processing circuitry 68, processor 70, communication interface 60 and radio interface 62 is configured to estimate (Block S164) accuracy of simple/other forms of compensation method(s) that are known in the art. In one or more embodiments, network node 16 such as via one or more of processing circuitry 68, processor 70, communication interface 60 and radio interface 62 is configured to a determine (Block S166) a PD method as a function of Blocks S154, S160, S162 and S164, i.e., PD method=f{X, Y, Z1, and Z2}. In one or more embodiments, network node 16 such as via one or more of processing circuitry 68, processor 70, communication interface 60 and radio interface 62 is configured to a determine (Block S168) whether the PD method is less than threshold 1. Thresholds are discussed herein. If the PD method is less than threshold 1, no delay compensation (i.e., PD compensation) is performed. If the PD method is greater than threshold 1, network node 16 such as via one or more of processing circuitry 68, processor 70, communication interface 60 and radio interface 62 is configured to determine (Block S170) whether the PD method is greater than or equal to threshold 1 and less than threshold 2. If the determination of Block S170, is true or YES, network node 16 such as via one or more of processing circuitry 68, processor 70, communication interface 60 and radio interface 62 is configured to use a first compensation method (Block S172). If the determination of Block S170 is false or NO, network node 16 such as via one or more of processing circuitry 68, processor 70, communication interface 60 and radio interface 62 is configured to a determine (Block S174) whether the PD method is greater than or equal to threshold 2. If the result of the logic of Block S174 is true or YES, network node 16 such as via one or more of processing circuitry 68, processor 70, communication interface 60 and radio interface 62 is configured to a use (Block S160) a RTT based compensation method (i.e., one type of PD compensation scheme). If the result/determination of Block S174 is false or NO, the process may end.
      the PD method determination may also include RF interface overhead that may depend on actual system 10 load. Further, inputs for the PD method (compensation scheme) determination may be continuously monitored and check if any changes to the input have occurred.

Additional Information of Liaison Statement (LS) on Propagation Delay Compensation for Reference Time Information Delivery

In this section, some issues related to PD compensation for clock synchronization are discussed.

1. Discussion

1.1 Propagation Delay (PD) Compensation for Reference Time Information Delivery

In LS, it is confirmed that Timing Advance (TA) based methods are utilized for PD compensation for the time synchronization accuracy analysis captured in Sec. 6.3.2.4. of 3GPP Technical Reference (TR) 38.825. The achievable time synchronization accuracy over Uu interface in Sec. 6.3.2.4 of 3GPP TR 38.825 is enough if following Radio Access Network 2 (RAN2) analysis on the overall time synchronization accuracy from sync master to wireless device as described in Sec. 6.3.5 of 3GPP TR 38.825. As the evaluation results on timing synchronization accuracy of Sec. 6.3.2.4 of 3GPP TR 38.825 can be achieved without additional 3GPP Release 16 (Rel-16) enhancements in addition to the required propagation delay compensation support, RAN1 sees no need for additional enhancements in Rel-16.

However, it should be noted that the analysis in sec 6.3.5 of 3GPP TR 38.825 was a generic analysis triggered by a LS from SA2 long before SA2 has finalized the synchronization solution, see Figure 5.27.1-1 in clause 5.27 in 3GPP Technical Specification (TS) 23.501. In the analysis by 3GPP TR 38.825, only two network-interface related inaccuracy parts are considered:
1. Inaccuracy on the Uu interface including downlink delay compensation and granularity of signaled reference timing;
2. Inaccuracy on the network interface between 5G GM clock and network node which sends the reference timing to the wireless device.

There are some missing inaccuracy components from, such as, the delivery of the 5G GM to the UPF, time stamping inaccuracy at DS-TT/NW-TT, the delivery of the time information to the network node's radio unit from the network node's baseband unit, the delivery of the time information to the end-station from the wireless device's radio interface, etc. Due to remote TSN GM clock entity, additional errors can be coupled at 5GS ingress (from TSN GM to NW-TT) with transportation over n hops of PTP (Sec 6.3.4.1 of 3GPP TR 38.825). Since these components are implementation- and deployment-related, to exactly estimate or even put requirements on each inaccuracy component might be challenging (if possible).

Observation 1 The inaccuracy analysis in 3GPP TR 38.825 is incomplete and cannot be used to justify not enhancing downlink delay compensation.

There may be an issue with the overall end-to-end inaccuracy (TSN grandmaster node to end-station connected to wireless device) in that it may easily go beyond 1 us, considering that the inaccuracy on the air-interface (545 ns) already takes half of the budget and uncertainty contributions from all possible components of the end-to-end path have not been accounted for. From deployment point of view, a much smaller air-interface inaccuracy provides the potential for supporting more use cases and increase the chances of satisfying the most demanding clock sync requirement when time synchronization deployments are realized.

Furthermore, 3GPP TS 22.104 V17.1.0 (September 2019) has the following new, Rel-17, requirements:
The 5G system shall be able to support arbitrary placement of sync master functionality and sync device functionality in integrated 5G/non-3GPP TSN networks.
The 5G system shall be able to support clock synchronization through the 5G network if the sync master and the sync devices are served by different wireless devices. (Flow of clock synchronization messages is in either direction, UL and DL.)

This indicates that the sync master can be located behind a wireless device 22. The clock synchronization message flow may have to pass two Uu interfaces. Therefore, this halves the error budget available for the Uu interfaces compared to the Rel-16 requirements. Such wireless device-to-wireless device E2E path with two air interfaces can pose much tighter requirements.

In conclusion, the current TA method can be utilized to apply PD compensation but the satisfaction of E2E 1 μs time synchronization budget cannot be guaranteed. Further, without knowing the Uu budget, any enhancement or proposal on PD compensation methods have may have a risk in creating redundant methods that again still may not satisfy the E2E time-synch requirement of 1 μs or lesser.

Observation 2 There is a need of PD compensation enhancement beyond current TA-based methods, but without knowing the Uu time synchronization budget, any enhancements or proposals may deem inadequate if E2E time-synchronization requirements cannot be satisfied.

Proposal 1 There is a need for specifying propagation delay compensation requirements and enhancements in order to meet the most stringent synchronization requirements of ≤1 μs in a large service area.

Due to the time limitation, and without the correct understanding of Uu time synchronization budget, RAN1 might not be able to further study the enhancements in the current release. As a result, the issue may addressed in the next Release. However, to achieve the objective E2E synchronization target, the pre-requisites need to be reconsidered in Release-17.

Observation 3 There is a need of change of pre-requisites when introducing new stricter dimensioning requirements in Release-17, e.g., time synchronization error budget allocation for Uu and other components within the E2E budget.

Proposal 2 The PD compensation methodology (with or without TA-based methods) and the related enhancements that can satisfy E2E time synchronization requirement should be targeted in Release-17.

1.2 Time Division Duplex (TDD) Aspects of Timing Advance (TA)-Based Compensation

The wireless device is equipped with time offset due downlink and uplink switching (n-TimingAdvanceOffset) in ServingCellConfigCommon information element (IE), which a wireless device 22 would typically acquire from SSB, MIB, or Ms when accessing the cell from IDLE. If the field n-TimingAdvanceOffset is absent, the wireless device 22 applies a default value defined for the duplex mode and frequency range of the serving cell. For FR1 TDD band without LTE-NR coexistence case, the default value is N_{TA, offset}=25600 (Tc). For FR2, the default value is N_{TA, offset}=13792 (Tc). Thus, the value of N_{TA, offset} is a cell-specific value and known to all wireless devices 22 in the cell.

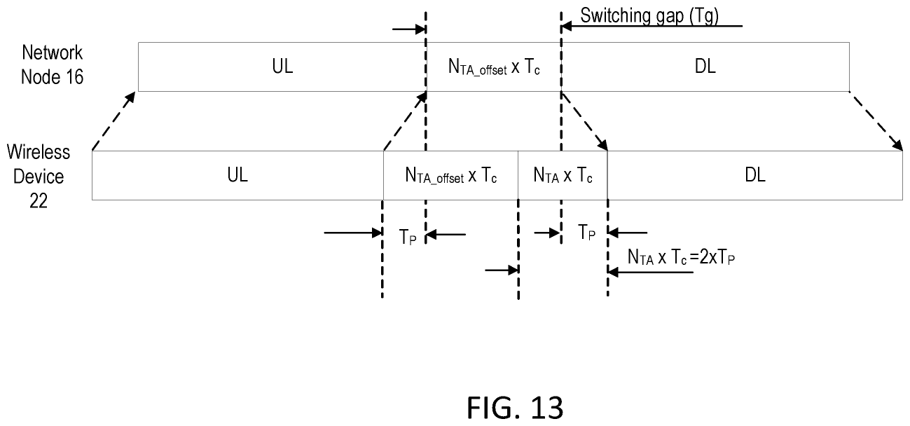

For TDD wireless device, the offset TA allows the TX-to-RX and RX-to-RX transition time as illustrated in FIG. 13 that is a diagram of timing advance with T_{TA}=(N_{TA}+N_{TA, offset})T_{c}.

3GPP TS 38.211 V15.6.0, Table 4.3.2-3: Transition Time N_{Rx-Tx} and N_{Tx-Rx}

| Transition time | FR1 | FR2 |
|---|---|---|
| N_{Tx-Rx} | 25600 | 13792 |
| N_{Rx-Tx} | 25600 | 13792 |

While for TDD operation, the UL timing is advanced by T_{TA}=(N_{TA}+N_{TA, offset})T_{c} relative to the DL timing at the wireless device, the timing advance command from the network node 16 provides N_{TA}. Thus the wireless device 22 is still able to derive propagation delay Tₚ from N_{TA}, Tₚ=N_{TA}×T_{c}/2.

Therefore, there may not be a need for any special treatment for in TA in relation to TDD aspects as both TA command (for N_{TA}) and the offset (N_{TA, offset}) are at wireless device disposal.

Proposal 3 For TDD communication, the TA command should indicate round-trip time measurement and therefore, does not require any special treatment.

2. Summary

Based on the discussion in the previous sections, one or more of the following is proposed:

Observation 1 The inaccuracy analysis in 3GPP TR 38.825 is incomplete and cannot be used to justify not enhancing downlink delay compensation.

Observation 2 There is a need of PD compensation enhancement beyond current TA-based methods, but without knowing the Uu time synchronization budget, any enhancements or proposals may deem inadequate if E2E time-synchronization requirements cannot be satisfied.

Observation 3 There is a need of change of pre-requisites when introducing new stricter dimensioning requirements in Release-17, e.g., time synchronization error budget allocation for Uu and other components within the E2E budget.

Proposal 1 There is a need for specifying propagation delay compensation requirements and enhancements in order to meet the most stringent synchronization requirements of ≤1 μs in a large service area.

Proposal 2 The PD compensation methodology (with or without TA-based methods) and the related enhancements that can satisfy E2E time synchronization requirement should be targeted in Release-17.

Proposal 3 For TDD communication, the TA command should indicate round-trip time measurement and therefore, does not require any special treatment.

Some Examples of One or More Embodiments

Example A1. A network node 16 configured to communicate with a wireless device 22 (WD 22), the network node 16 configured to, and/or comprising a radio interface 62 and/or comprising processing circuitry 68 configured to:

determine one of a plurality of Propagation Delay (PD) compensation schemes for the wireless device 22 implement based at least in part on at least one characteristic associated with the wireless device 22; and

indicate the one of the plurality of PD compensation schemes for the wireless device 22 to implement.

Example A2. The network node 16 of Example A1, wherein the one of the plurality of PD compensation scheme is configured to reduce a signaling overhead when compared to at least one other of the plurality of PD compensation schemes.

Example A3. The network node 16 of Example A1, wherein the at least one characteristic associated with the wireless device 22 includes at least one of wireless device capability, location of the wireless device, proximity of the wireless device 22 to other wireless devices 22, transmission path estimation, channel properties, synchronization properties and at least one wireless device operational target.

Example B 1. A method implemented in a network node 16 that is configured to communicate with a wireless device 22, the method comprising:

determining one of a plurality of Propagation Delay (PD) compensation schemes for the wireless device 22 implement based at least in part on at least one characteristic associated with the wireless device 22; and

indicating the one of the plurality of PD compensation schemes for the wireless device 22 to implement.

Example B2. The method of Example B1, wherein the one of the plurality of PD compensation scheme is configured to reduce a signaling overhead when compared to at least one other of the plurality of PD compensation schemes.

Example B3. The method of Example B 1, wherein the at least one characteristic associated with the wireless device includes at least one of wireless device capability, location of the wireless device 22, proximity of the wireless device 22 to other wireless devices 22, transmission path estimation, channel properties, synchronization properties and at least one wireless device operational target.

Example C1. A wireless device 22 (WD 22) configured to communicate with a network node 16, the WD 22 configured to, and/or comprising a radio interface 82 and/or processing circuitry 84 configured to:

receive an indication of one of a plurality of Propagation Delay (PD) compensation schemes for the wireless device 22 to implement, the one of the plurality of PD compensation schemes to implement being based at least in part on at least one characteristic associated with the wireless device 22; and

implement the one of the plurality of PD compensation schemes.

Example C2. The WD 22 of Example C1, wherein the determined one of the plurality of PD compensation scheme reduce a signaling overhead when compared to at least one other of the plurality of PD compensation schemes.

Example C3. The WD 22 of Example C1, wherein the at least one characteristic associated with the wireless device 22 includes at least one of: wireless device capability, location of the wireless device 22, proximity of the wireless device 22 to other wireless devices 22, transmission path estimation, channel properties, synchronization properties and at least one wireless device operational target.

Example D1. A method implemented in a wireless device 22 (WD 22), the method comprising:

receiving an indication of one of a plurality of Propagation Delay (PD) compensation schemes for the wireless device 22 to implement, the one of the plurality of PD compensation schemes to implement being based at least in part on at least one characteristic associated with the wireless device; and

implementing the one of the plurality of PD compensation schemes

Example D2. The method of Example D1, wherein the determined one of the plurality of PD compensation scheme reduce a signaling overhead when compared to at least one other of the plurality of PD compensation schemes.

Example D3. The method of Example D1, wherein the at least one characteristic associated with the wireless device 22 includes at least one of: wireless device capability, location of the wireless device 22, proximity of the wireless device 22 to other wireless devices, transmission path estimation, channel properties, synchronization properties and at least one wireless device operational target.

Therefore, one or more embodiments described herein advantageously provide identifying methods for providing wireless devices 22 with the ability to identify a value for the downlink PD compensation so that the wireless devices 22 can adjust the value of received external TSN clocks using the identified downlink PD compensation. This then results in wireless devices 22 establishing a current value for external TSN clocks with an acceptable level of uncertainty relative to the value of that TSN clock in its corresponding source network node 16 serving as the master TSN clock (e.g. the Grandmaster (GM) clock). The specific method for PD compensation selected can be based on the level of accuracy (uncertainty) required for the TSN clocks of interest to wireless devices 22 and the loading experienced on the radio interface of the cells in which external TSN clocks are needed by wireless devices.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:

| Abbreviation | Explanation |
|---|---|
| 3GPP | 3rd Generation Partnership Project |
| 5G | 5th Generation |
| 5GS | 5G System |
| CE | Control Element |
| DL | Downlink |
| D2D | Device-To-Device |
| gNB | Next Generation NodeB |
| LTE | Long-Term Evolution |
| MAC | Media Access Control |
| NR | New Radio |
| OTA | Over-The-Air |
| PD | Propagation Delay |
| ppb | Parts Per Billion |
| PTP | Precision Time Protocol |
| RAR | Radio Access Response |
| RRC | Radio Resource Control |
| RTT | Round Trip Time |
| SFN | Super-Frame Number |
| SIB | System Information Block |
| TA | Timing Advance |
| TTI | Transmission Time Interval |
| TS | Time Synchronization |
| UE | User Equipment |
| UL | Uplink |
| URLLC | Ultra-Reliable and Low-Latency Communications |

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A network node for a wireless communication system, the network node comprising:
processing circuitry configured to:
send a wireless system clock and a network clock different from the wireless system clock, the network clock being adjustable based at least on the wireless system clock;
determine one of a plurality of Propagation Delay, PD, compensation schemes for a first wireless device to implement based at least in part on at least one characteristic associated with the first wireless device; and
indicate the one of the plurality of PD compensation schemes to the first wireless device for adjustment of the wireless system clock.

2. The network node of claim 1, wherein the adjustment of the wireless system clock is for use in performing a time stamping operation that measures a delay experienced when the network clock is relayed from a wireless system ingress point to a wireless system egress point where the measured delay is used for adjusting the network clock; and
the time stamping operation meeting an accuracy requirement of the network clock.

3. The network node of claim 1, wherein the processing circuitry is further configured to:
determine a plurality of regions of a cell associated with the network node, the regions being defined based at least in part on at least one factor; and
determine the first wireless device to be in one of the plurality of regions, the one of the plurality of PD compensation schemes determined for the first wireless device to implement being based on the determination that the first wireless device is in the one of the plurality of regions.

4. The network node of claim 3, wherein the at least one factor includes at least one of:
a radial distance of coverage of the network node;
a cell sector;
at least one channel property;
bandwidth part, BWP, of a carrier used to communicate with the first wireless device;
first wireless device altitude;
mobility rate of the first wireless device;
mobility rate of the network node; and
physical obstructions in the cell.

5. The network node of claim 3, wherein the processing circuitry is further configured to select a delivery method for sending the wireless system clock to the first wireless device based at least on the determination that the first wireless device is in the one of the plurality of regions.

6. The network node of claim 3, wherein the processing circuitry is further configured to:
receive an indication of an accuracy requirement of the network clock to be met when relayed from a wireless system ingress point to a wireless system egress point;
estimate a respective accuracy limitation of at least a subset of the plurality of PD compensation schemes;
define a plurality of thresholds based at least in part on the respective accuracy limitation of at least the subset of the plurality of PD compensation schemes, each respective threshold of the plurality of thresholds being associated with a respective one of the plurality of PD compensation schemes; and
the determination of the one of the plurality of PD compensation schemes for the first wireless device to implement being based on the accuracy limitation of the one of the plurality of PD compensation schemes meeting one of the plurality of thresholds that supports the accuracy requirement of the network clock.

7. (canceled)

8. (canceled)

9. The network node of claim 1, wherein the one of the plurality of PD compensation schemes determined for the first wireless device to implement is configured to reduce a signaling overhead and/or to reduce power consumption at the first wireless device when compared to at least one other of the plurality of PD compensation schemes.

10. The network node of claim 1, wherein the at least one characteristic associated with the first wireless device is a wireless device specific characteristic including at least one of:
the first wireless device capability;
a location of the first wireless device relative to the network node;
transmission path estimation associated with the first wireless device;
channel properties between the network node and the first wireless device;
synchronization properties associated with at least one of the network node and first wireless device; and
at least one wireless device operational requirement.

11. The network node of claim 1, wherein the processing circuitry is further configured to:
detect that a plurality of wireless devices have capability for side link communications;
determine a group of the plurality of wireless devices that are within a predefined proximity to at least one other wireless device in the group, the group including the first wireless device; and
select the first wireless device to be a primary wireless device of the group, the primary wireless device being configured to send a PD value, associated with the indicated one of the plurality of PD compensation schemes determined for the first wireless device to implement, to the remaining wireless devices in the group for adjusting the wireless system clock.

12. The network node of claim 11, wherein the group includes at least one wireless device associated with a different accuracy requirement for the network clock than the other wireless devices in the group, the indicated one of the plurality of PD compensation schemes determined for the first wireless device to implement satisfying a strictest accuracy requirement of the different accuracy requirements for the network clock.

13. (canceled)

14. The network node of claim 12, wherein the processing circuitry is further configured to determine that a difference in propagation delay for the wireless devices in the group is less than a predefined value.

15. The network node of claim 1, wherein the plurality of PD compensation schemes include at least one of a round trip time, RTT, based scheme, a non-RTT based scheme, zero PD compensation scheme and a side link based scheme.

16. The network node of claim 1, wherein the wireless system clock is a 5^{th} Generation, 5G, system clock and the network clock is a time-sensitive network, TSN, clock.

17. A first wireless device for a wireless communication system, the first wireless device comprising:
processing circuitry configured to:
receive a wireless system clock and a network clock different from the wireless system clock, the network clock being adjustable based at least on the wireless system clock;
receive an indication of one of a plurality of Propagation Delay, PD, compensation schemes for the first wireless device to implement, the one of the plurality of PD compensation schemes being specific to the first wireless device based at least in part on at least one characteristic associated with the first wireless device; and
adjust the wireless system clock using a PD value determined using the one of the plurality of PD compensation schemes.

18. The first wireless device of claim 17, wherein the processing circuitry is further configured to:
use the adjusted wireless system clock to perform a time stamping operation by measuring a delay experienced when the network clock is relayed from a wireless system ingress point to a wireless system egress point; and
use the measured delay for adjusting the network clock, the adjusting of the network clock resulting in a network clock, at the wireless device, having a level of timing uncertainty within a predefined range relative to its grandmaster clock.

19. The first wireless device of claim 18, wherein the one of the plurality of PD compensation schemes that is indicated to the first wireless device is based at least on the accuracy requirement of the network clock.

20. The first wireless device of claim 17, wherein the one of the plurality of PD compensation schemes determined for the first wireless device to implement is configured to reduce a signaling overhead and/or to reduce power consumption at the first wireless device when compared to at least one other of the plurality of PD compensation schemes.

21. The first wireless device of claim 17, wherein the at least one characteristic associated with the first wireless device is a wireless device specific characteristic including at least one of:
the first wireless device capability;
a location of the first wireless device relative to a network node;
transmission path estimation associated with the first wireless device;
channel properties between the network node and first wireless device;
synchronization properties associated with at least one of the network node and first wireless device; and
at least one wireless device operational requirement.

22. The first wireless device of claim 17, wherein the processing circuitry is further configured to:
indicate a capability for side link communications to a network node;
receive an indication that the first wireless device has been selected as a primary wireless device of a group of a plurality of wireless devices that are within a predefined proximity to at least one other wireless device in the group; and
send a PD value, associated with the indication of one of the plurality of PD compensation schemes for the first wireless device to implement, to the remaining wireless devices in the group for adjusting the wireless system clock.

23. The first wireless device of claim 22, wherein the group includes at least one wireless device associated with a different accuracy requirement for the network clock than the other wireless devices in the group, the indicated one of the plurality of PD compensation schemes determined for the first wireless device to implement satisfying a strictest accuracy requirement of the different accuracy requirements for the network clock.

24. (canceled)

25. The first wireless device of claim 22, wherein a difference in propagation delay for the wireless devices in the group is less than a predefined value.

26. (canceled)

27. The first wireless device of claim 17, wherein the plurality of PD compensation schemes include at least one of a round trip time, RTT, based scheme, a non-RTT based scheme, zero PD compensation scheme and a side link based scheme.

28. The first wireless device of claim 17, wherein the wireless system clock is a 5^{th} Generation, 5G, system clock and the network clock is a time-sensitive network, TSN, clock.

29. A method performed by a network node of a wireless communication system, the method comprising:
sending a wireless system clock and a network clock different from the wireless system clock, the network clock being adjustable based at least on the wireless system clock;
determining one of a plurality of Propagation Delay, PD, compensation schemes for a first wireless device to implement based at least in part on at least one characteristic associated with the first wireless device; and
indicating the one of the plurality of PD compensation schemes to the first wireless device for adjustment of the wireless system clock.

30.-44. (canceled)

45. A method performed by a first wireless device of a wireless communication system, the method comprising:
receiving a wireless system clock and a network clock different from the wireless system clock, the network clock being adjustable based at least on the wireless system clock;
receiving an indication of one of a plurality of Propagation Delay, PD, compensation schemes for the first wireless device to implement, the one of the plurality of PD compensation schemes being specific to the first wireless device based at least in part on at least one characteristic associated with the first wireless device; and
adjusting the wireless system clock using a PD value determined using the one of the plurality of PD compensation schemes.

46.-56. (canceled)
